(19) United States
(12) Patent Application Publication
(10) Pub. No.: US 2013/0287927 A1
(43) Pub. Date: Oct. 31, 2013

(54) PREPARATION METHOD AND SYSTEM FOR CLARIFIED PLUM WINE AND PLUM EXTRACT

(71) Applicants: Zer-Ran YU, Chiayi City (TW); Be-Jen Wang, Chiayi City (TW)

(72) Inventors: Zer-Ran YU, Chiayi City (TW); Be-Jen Wang, Chiayi City (TW)

(21) Appl. No.: 13/455,542

(22) Filed: Apr. 25, 2012

(51) Int. Cl. C12H 1/06; A23L 1/308; C12G 1/00

(52) U.S. Cl. 426/648; 426/431; 99/276

(57) ABSTRACT

The present invention provides a preparation method and system for clarified plum wine and plum extract, blanching plum at 95° C. for 5 minutes, and then extracting the blanched plum with extracting solution containing 70-75% alcohol in volume ratio of 1:2 (w/v) at 8˜10° C. in vacuum for 30 minutes before centrifugation, cooling clarification of the plum juice at −8° C. and −20° C. is carried out immediately for 30 minutes respectively, so as to obtain clarified plum wine. Afterwards, the plum wine is concentrated in vacuum to ⅕ of original volume to obtain clarified plum extract; therefore, high quality plum wine and plum extract can be obtained without destroying the plum tissue, and the production efficiency is quite ideal.

### BACKGROUND OF INVENTION

1. Field of the Invention

The present invention relates generally to the extraction of active ingredients of plum, and more particularly to the preparation method and system for clarified plum wine and plum extract.

2. Description of Related Art

Prunus mume, commonly known as plum or mei, is the fruit of rosaceous fruit tree of stone fruits in the temperate zone. The peel color is greenish yellow or light pink, and it is mainly processed to plum wine, prune and confection. Plum comprises rich oxidation resistant substances such as citric acid 11.9-16.5 mg/mL, ascorbic acid 8.2-11.3 mg/100 mL and polyphenols 4.8-7.6 mg/mL. It is regarded as an alkaline fruit beneficial to health. These oxidation resistant substances can strengthen human body's oxidation resistance, prevent and avoid the attack of cancer, stroke and coronary heart disease.

There will be precipitates produced after 4-6 hours extraction of plum by pulp finisher, which will influence the quality and appearance, therefore, the clarification is required. The traditional plum juice clarification method is to add clarifying agents in the juice and store the juice at 5˜10° C. for 20˜30 hours before adding diatomite to assist in filtration. The modern method is to use the pore size of microfiltration membrane to exclude pectins and fibers, so as to clarify the fruit juice. However, the pectinase still needs to be added in the processing procedure to decompose pectins, and the fibers should be removed by centrifugation, so as to avoid these substances causing fouling of membrane and concentration polarization that influence the flux of membrane.

Secondly, the long-term alcohol impregnation is generally used in traditional plum wine making, sometimes the impregnation solution is mixed with 20˜30% fructose or sucrose, and the alcohol concentration is controlled at about 40%. After 3 to 4 months of impregnation, the impregnation liquid is filtered and clarified. However, there still are macromolecular substances such as pectins depositing on the bottom layer after several days of storage, that influence the appearance of plum wine significantly.

In traditional plum extract production, plum is pressed and filtered before direct heating for concentration by evaporation, the plum juice comprises more than 90% moisture and pectin substance, the time for concentration by evaporation is long, the plum extract is likely to be carbonized and the functional components such as ascorbic acid and polyphenols are likely to be destroyed.

### SUMMARY OF THE INVENTION

The fundamental purpose of the present invention is to provide a preparation method and system for clarified plum wine and plum extract, so as to make high quality clarified plum wine and plum extract completely reserving the flavor development substances of plum and oxidation resistant functional components of polyphenols without destroying the tissue of plum, and the production efficiency is high.

Therefore, in order to attain the aforesaid purpose, the present invention provides a preparation method for clarified plum wine and plum extract, the extracting solution containing alcohol is fast sucked into the cells of plum tissue by vacuum extraction without destroying plum peel surface and flesh tissue, and the active constituents such as organic acid, polyphenols, vitamin and flavor development substances are seperated out of plum rapidly by centrifugation, and then processed by two-stage subzero low temperature clarification to obtain well clarified plum wine and plum extract.

### BRIEF DESCRIPTION OF THE DRAWINGS

FIG. 1 is a sketch diagram of the continuous separation system of the preferred embodiment of the present invention.

FIG. 2 is a flow chart of a preferred embodiment of the present invention.

### DETAILED DESCRIPTION OF THE INVENTION

The features and the advantages of the present invention will be more readily understood upon a thoughtful deliberation of the following detailed description of two preferred embodiments of the present invention with reference to the accompanying drawings.

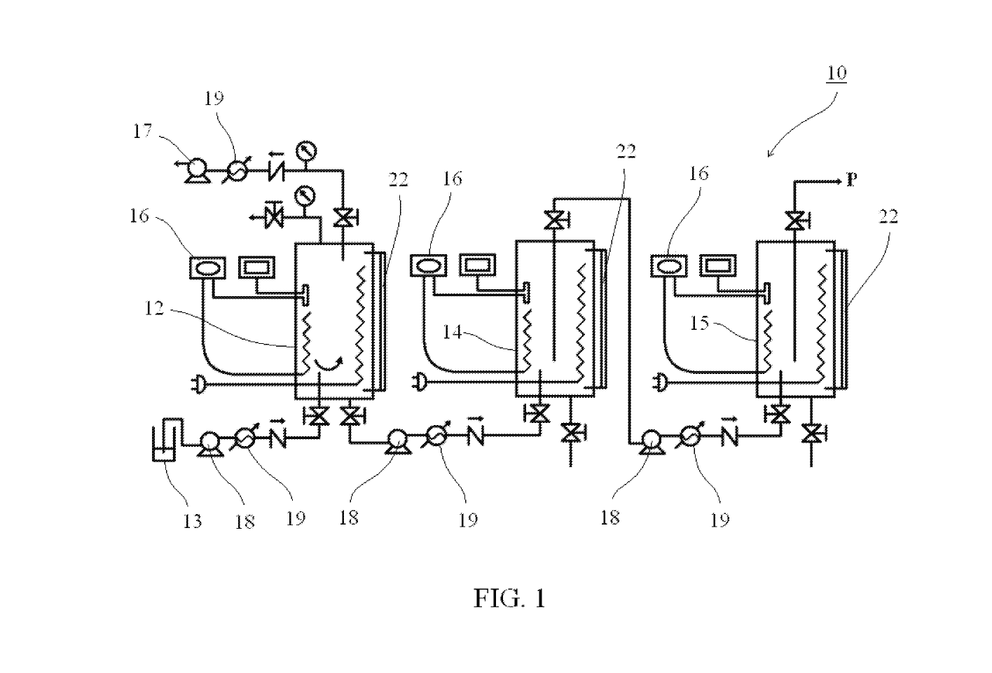

Referring to FIG. 1, a good implementation example of preparation method for clarified plum wine and plum extract uses a system 10 to make plum wine and plum extract, this system 10 comprises of an extracting centrifugal tank 12, an extracting solution container 13, a first clarification tank 14, a second clarification tank 15, and three temperature controllers 16, a vacuum pump 17, three conveying pumps 18, four precoolers 19, and temperature indicators, valves and non-return valves.

The extracting centrifugal tank 12 comprises of a stainless steel tank and a centrifugal apparatus inside the tank for containing plum and extracting solution and implementing vacuum extraction for plum, the plum wine is obtained from separation. The extracting solution container 13 is connected to the extracting centrifugal tank 12 for containing the extracting solution with 70˜75% alcohol. The first clarification tank 14 is a stainless steel tank connected to the extracting centrifugal tank 12, for low-temperature precipitation of the plum wine separated by the extracting centrifugal tank 12. The second clarification tank 15 connected to the first clarification tank 14 is also a stainless steel tank, for lower temperature precipitation process of the clarified plum wine from the first clarification tank 14, so as to obtain clarified plum wine. In addition, there is a window 22 on one side of the extracting centrifugal tank 12, the first and the second clarification tank 14, 15 respectively, the window 22 is made of vacuum proof and low temperature proof transparent materials, it can be marked with scale, through which, the content in the extracting centrifugal tank 12 and in the first and the second clarification tank can be observed. The temperature controllers 16 are respectively connected to the extracting centrifugal tank 12 and the first and the second clarification tank 14, 15 for controlling the temperature inside the extracting centrifugal tank 12 and the first and the second clarification tank 14, 15. The vacuum pump 17 is connected to the top of the extracting centrifugal tank 12 to vacuumize the extracting centrifugal tank 12. The conveying pumps 18 respectively connect the extracting solution container 13 to the extracting centrifugal tank 12, the extracting centrifugal tank 12 to the first clarification tank 14, and the first 14 to the second clarification tank 15, for conveying extracting solution and plum wine. The precoolers 19 respectively connect vacuum pump 17, conveying pumps 18 and extracting centrifugal tank 12, the first and the second clarification tank 14, 15.

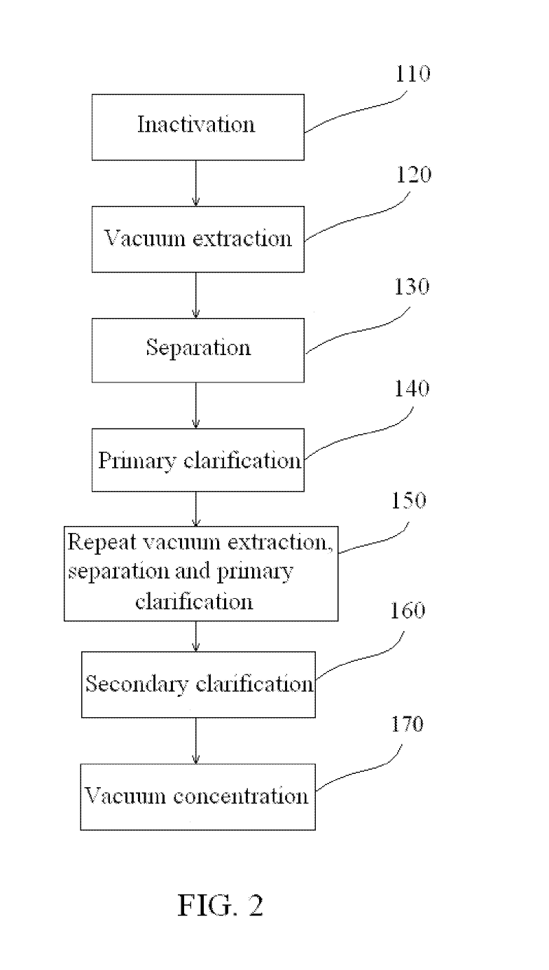

Referring to FIG. 2, this preparation method for clarified plum wine and plum extract will not destroy the outer skin and the internal structure of plum, the breakage rate of plum is controlled below 1%. The first step is blanching 110: processing plum at high temperature, the blanching conditions include temperature 95° C., time 5 minutes, the plum maturity is 60˜70%, the purpose is to completely reserve the plum structure and its nutrient and functional components without destroying the peel and flesh tissue.

The second step of the present invention is vacuum extraction 120: adding the extracting solution containing alcohol in the blanched plum for vacuum extraction, so that the extracting solution can be sucked into the cells of plum tissue rapidly. The extracting solution comprises 70-75% alcohol (supplied from rice wine, Kaoliang spirit, corn alcohol and molasses alcohol). The volume ratio of plum to the extracting solution is 1:2 (w/v). The conditions for vacuum extraction are temperature 8˜10° C., vacuum gauge pressure 65˜70 cmHg, and 30 minutes extraction (adjusted according to the maturity, variety and blanching of plum).

The third step of the present invention is separation 130: to obtain plum wine and leave plum residue by centrifugation, to separate active constituents such as organic acid, polyphenols, vitamin and flavor development substances out of plum to the plum wine.

The fourth step of the present invention is primary clarification 140: low temperature precipitation of plum wine inside the first clarification tank 14 (conveying pump 18 conveys the centrifugated plum juice to the first clarification tank 14), to separate clear plum wine from turbid plum wine, the temperature is controlled at −8° C. (jointly controlled by temperature controller 16 and precooler 19), the sedimentation time is about 30 minutes.

The fifth step of the present invention is to repeat vacuum extraction, separation and primary clarification 150.

The sixth step of the present invention is secondary clarification 160: lower temperature precipitation of the clarified plum wine derived from primary clarification (conveying pump 18 conveys the clarified plum wine from the top of the first clarification tank 14 to the second clarification tank 15), so as to obtain clarified plum wine (taken out from the top P of the second clarification tank 15) and turbid plum wine, the temperature is controlled at −20° C., the sedimentation time is about 30 minutes.

The final step of the present invention is vacuum concentration 170: vacuum concentration of a part of plum wine is carried out at 40˜45° C. under the vacuum gauge pressure of 65˜70 cmHg, concentrating the plum wine to ⅕ of original volume in vacuum, so as to obtain clarified plum extract.

As mentioned above, the vacuum extraction 120 and centrifugation 130 steps are carried out inside the extracting centrifugal tank 12.

Thereby high-clarity plum wine and plum extract can be obtained. The plum residue derived from vacuum extraction 120 and centrifugation 130 can be mixed with the residual turbid plum wine derived from clarification 140, 160 to make highly dietary fiber plum food with fibers and pectins.

In order to compare the effect of the present invention with that of known technique, four batches of plum are processed under the plum blanching conditions of 95° C. and 5 minutes, the following experiments are carried out: (1) the blanched plum is mixed with 70˜75% alcoholic solution in four times of volume, pressed by pulp finisher to obtain plum wine; (2) the plum wine obtained from (1) is clarified by France Novasep produced Carbosep M14, ZrO₂/TiO₂ ceramic microfiltration membrane with filter membrane pore 0.14 μm; (3) still impregnation: the blanched plum is mixed with 70˜75% alcoholic solution in four times of volume, impregnated for 3 months to obtain soaked plum wine; (4) method of the present invention.

The plum extract liquor was obtained from the four processing modes. The solution of four batches of plum is taken out to analyze the following physico-chemical properties: (1) apparent viscosity, (2) color, (3) pectin content, (4) total solids, (5) ascorbic acid and citric acid content, (6) polyphenol content and (7) total antioxidant activity, and the vacuum concentration velocities of four processes are compared. The apparent viscosity is measured at 20° C., the apparent viscosity value is measured by the viscosimeter LV NO. 2 spindle produced by Brookfield company at rotation speed of 60 rpm, expressed in cPs. The color change is measured by Japan Denshoku Σ90 color difference meter, expressed as Hunter L, a and b values. The pectin and total solids content is measured as per U.S. AOAC method, expressed in mg/mL. Ascorbic acid and citric acid content is quantified by HPLC method, expressed in mg/100 mL and mg/mL. The total phenol content is compared with gallic acid (GA) as standard by adding Folin-Ciocalteu's reagent at 760 nm absorbance, expressed in mg GA/mL. The total antioxidant activity is obtained by measuring the ability to chelate 2,2′-azino-bis free radicals (the ability to scavenge ABTS radicals), expressed in IC₅₀, i.e. the required mg/mL concentration for preventing 50% lipid peroxidation. The vacuum concentration velocities are compared by 20 L vacuum concentrator, the condensate amount evaporated from 10 L plum juice sample per hour at 50 rpm, 40° C. under vacuum gauge pressure of 70 cmHg, expressed in L/hr.

The comparison of experimental results comprises four parts: (1) changes in apparent viscosity, total solids content and pectin content in clarification, (2) changes in color and clarity, (3) changes in ascorbic acid, citric acid and polyphenol content and total antioxidant activity, (4) comparison of concentration velocity, the data are analyzed in Tables 1, 2 and 3.

Table 1 shows that the apparent viscosity, total solids content and pectin content of the present invention and microfiltration membrane treated plum wine are lower than that of the pulp finisher extracted or impregnated plum wine, therefore, the clarified plum wine made by the present invention tastes smooth.

TABLE 1

| | | | | Vacuum |
|---|---|---|---|---|
| | | | | impregnation |
| Analytical | Pulp | Micro- | Still | with cooling |
| items | finisher | filtration | impregnation | clarification |
| Total | | | | |
| solids(mg/mL) | 104.7 ± 1.2 | 51.2 ± 0.6 | 95.7 ± 1.3 | 52.4 ± 0.7 |
| Pectin(mg/mL) | 14.5 ± 0.5 | — | 14.1 ± 0.6 | — |
| Apparent | 19.4 ± 0.3 | 7.3 ± 0.1 | 23.5 ± 0.4 | 7.3 ± 0.2 |
| viscosity(cPs) | | | | |
| Color | | | | |
| L | 36.24 ± 0.62 | 90.12 ± 1.22 | 30.72 ± 0.77 | 91.01 ± 0.92 |
| a | 10.12 ± 0.37 | 5.22 ± 0.28 | 14.82 ± 0.52 | 5.09 ± 0.13 |
| b | 15.88 ± 0.66 | 10.67 ± 0.49 | 20.33 ± 0.65 | 11.68 ± 0.39 |

—: not detectable

The present invention can separate functional components out of plum liquor while cooling the precipitates to remove pectin, fiber, tannin and protein components out of plum liquor without destroying the peel and flesh tissue of plum, so as to avoid precipitates or suspended substances in the plum wine influencing taste and appearance. Direct juicing or impregnation of plum will break and destroy the outer skin and flesh tissue of plum, so that a lot of pectin, fiber, tannin and protein are extracted, and the plum liquor is likely to have macromolecular aggregating precipitates or suspension, thus, the apparent viscosity of plum liquor is increased, and the total solids content is increased as the pectin content is high. When the microfiltration membrane is used to clarify the plum liquor pressed from plum by pulp finisher, as a large amount of pectin and fiber constituents have been extracted, the pectinase must be added in to decompose pectins and to remove fibers by concentration, so as to avoid the fouling of membrane and concentration polarization resulted from pectins and fibers in the membrane filtration treatment reducing the flux of membrane.

Secondly, the pulp finisher extracted plum comprises a lot of pectin component resulting in the clarity Hunter L-value of 36.24, and the L-value approaches to 30.72 as the outer skin and flesh tissue of plum are destroyed after impregnation treatment. Hunter L-value can be expressed as 0 to 100, the closer it is to 100, the higher the transparency and clarity are. The present invention can completely remove the precipitates formed of few pectin substances. Although the microfiltration membrane treatment can attain the same clarification effect, the treatment of the pectin substance is likely to reduce the operating rate and obstruct membrane cleaning, so that the operating cost is increased.

Furthermore, as shown in Table 1, the larger the Hunter a value is, the deeper the red chromaticity is. The larger the Hunter b value is, the deeper the yellow depth is, the pressed or impregnated plum wine has high cloudiness, it shows deeper red and yellow, therefore, its appearance, color and clarity are hardly acceptable. The present invention prepared plum wine is transparent and clear, with charming color of light reddish yellow and bright clear appearance, it is a charming plum wine product.

As shown in Table 2, the present invention prepared plum wine and plum extract have good clarity, as well as high ascorbic acid, citric acid, polyphenol content and high total antioxidant activity. The total antioxidant activity (IC₅₀) represents the required concentration for scavenging free radical 50% formation, when the required IC₅₀ concentration is low, meaning there is good antioxidant activity to scavenge free radical to prevent the formation of lipid peroxidation, and to strengthen the activity of antioxidant enzymes superoxide dismutase (SOD), catalase (CAT) and glutathione peroxidase (GSH-Px) to strengthen the immunologic function of human body.

TABLE 2

| | | | | Vacuum |
|---|---|---|---|---|
| | | | | impregnation |
| Analytical | Pulp | Micro- | Still | with cooling |
| items | finisher | filtration | impregnation | clarification |
| Ascorbic | 10.4 ± 0.3 | 12.5 ± 0.2 | 7.2 ± 0.1 | 13.1 ± 0.4 |
| acid(mg/100 mL) | | | | |
| Citric | 12.7 ± 0.4 | 15.2 ± 0.4 | 8.9 ± 0.2 | 15.9 ± 0.3 |
| acid(mg/mL) | | | | |
| Polyphenol(mg | 7.6 ± 0.3 | 9.0 ± 0.1 | 5.0 ± 0.3 | 9.3 ± 0.2 |
| GA/mL) | | | | |
| IC₅₀(mg/mL) | 6.1 ± 0.3 | 4.1 ± 0.2 | 7.3 ± 0.3 | 3.7 ± 0.1 |

IC₅₀: the required concentration to inhibit 50% lipid peroxidation.

The present invention prepared clarified plum wine comprises about 70% alcohol concentration, it can be concentrated at 40° C. under vacuum gauge pressure of 70 cmHg. As shown in Table 3, the concentration velocity of the present invention extracted plum liquor is higher than that of pressed and impregnated plum.

To sum up, the present invention extracts all functional components of plum in vacuum without destroying the plum tissue, and implements subzero clarification process, the quality and efficiency are almost ideal. The clarified plum wine can be directly concentrated to plum extract, or concentrated to 5˜50% alcohol concentration, or mixed with alcoholic solution of sucrose or fructose to make sweet plum wine or sweet plum extract products with 5˜10% alcohol content. The plum wine and plum extract can be taken as functional drink, flavoring wine and health food, and the residual plum from extraction can be pressed to make plum jam with highly dietary fiber.

In addition, the preparation method and system of the present invention can be applied not only to processed products of plum, but also to prune, juicy peach and

TABLE 3

| | L/hr | | | |
|---|---|---|---|---|
| | | | | Vacuum |
| | | | | impregnation |
| | Pulp | Micro- | Still | with cooling |
| Time(hr) | finisher | filtration | impregnation | clarification |
| 0.5 | 3.6 ± 0.2 | 4.1 ± 0.1 | 3.5 ± 0.2 | 4.2 ± 0.2 |
| 1 | 3.0 ± 0.1 | 3.6 ± 0.3 | 3.1 ± 0.1 | 3.7 ± 0.1 |
| 2 | 2.2 ± 0.2 | 2.8 ± 0.1 | 2.2 ± 0.1 | 2.9 ± 0.2 |
| 3 | 1.9 ± 0.2 | 2.4 ± 0.2 | 2.0 ± 0.2 | 2.4 ± 0.2 |

Chinese date processing.

What is claimed is:

1. A preparation method for clarified plum wine and plum extract comprises at least the following steps:
vacuum extraction: add a moderate amount of alcoholic extracting solution in the blanched plum for vacuum extraction, so that the extracting solution can be sucked into the cells of plum tissue rapidly;
separation: to obtain plum wine and leave plum residue by centrifugation, to separate active constituents such as organic acid, polyphenols, vitamin and flavor development substances out of plum to the plum wine;
primary clarification: low temperature precipitation of separated plum wine is carried out for preset time to separate clarified plum wine from turbid plum wine;
repeat vacuum extraction, separation and primary clarification once again;
secondary clarification: precipitation at lower temperature is carried out for the clarified plum wine to obtain clarified plum wine and turbid plum wine; and
vacuum concentration: vacuum concentration of a part of plum wine is carried out at the preset temperature to obtain clarified plum extract.

2. The method defined in claim 1, wherein there is an blanching step before the vacuum extraction, for high-temperature processing of plum for preset time.

3. The method defined in claim 1, wherein the plum breakage rate must be controlled below 1% in the principle of not destroying the outer skin and internal structure of plum.

4. The method defined in claim 2, wherein in the step of blanching, the blanching conditions are temperature 95° C., time 5 minutes and plum maturity about 60˜70%.

5. The method defined in claim 1, wherein in the step of vacuum extraction, the extracting solution comprises 70-75% alcohol, the volume ratio of plum to the extracting solution is 1:2 (w/v), the conditions of vacuum extraction are temperature 8˜10° C., vacuum gauge pressure 65˜70 cmHg and 30 minutes extraction.

6. The method defined in claim 1, wherein the temperature of primary clarification is controlled at −8° C., and the temperature of secondary clarification is controlled at −20° C.

7. The method defined in claim 6, wherein the sedimentation time in the primary and secondary clarification steps is about 30 minutes.

8. The method defined in claim 1, wherein in the step of vacuum concentration, the plum wine is concentrated in vacuum to ⅕ of original volume at 40˜45° C. under vacuum gauge pressure of 65˜70 cmHg.

9. The method defined in claim 1, wherein the plum residue from vacuum extraction and separation can be mixed with the residual turbid plum wine from clarification to make highly dietary fiber plum food with fibers and pectins.

10. The method defined in claim 1, wherein comprises of:
an extracting centrifugal tank, for containing plum and extracting solution and extracting plum in vacuum, separating to obtain plum wine;
an extracting solution container, connected to the extracting centrifugal tank, for conveying extracting solution into the extracting centrifugal tank;
a first clarification tank, connected to the extracting centrifugal tank, for low temperature precipitation of plum wine; and
a second clarification tank, connected to the top of first clarification tank, for lower temperature precipitation of clarified plum wine.

11. The system defined in claim 10, wherein there is a window on one side of the extracting centrifugal tank, the first and the second clarification tank respectively, the window is made of vacuum proof and low temperature proof transparent materials.

12. The system defined in claim 10, wherein the extracting centrifugal tank and the first and the second clarification tank are stainless steel tanks, and there is a centrifugal apparatus inside the extracting centrifugal tank.

13. The system defined in claim 10, wherein comprises of three temperature controllers, respectively connected to the extracting centrifugal tank, the first and the second clarification tank.

14. The system defined in claim 10, wherein comprises of:
a vacuum pump, connected to the top of the extracting centrifugal tank;
three conveying pumps, respectively connecting the extracting solution container to the extracting centrifugal tank, the extracting centrifugal tank to the first clarification tank, and the first to the second clarification tank; and
four precoolers, respectively connecting vacuum pumps, conveying pumps to the extracting centrifugal tank, the first and the second clarification tank.
